(19) United States
(12) Patent Application Publication
(10) Pub. No.: US 2019/0101689 A1
(43) Pub. Date: Apr. 4, 2019

(54) LIGHT GUIDE PLATE, LIGHT GUIDE PLATE MODULE, BACKLIGHT MODULE AND DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Dong CUI, Beijing (CN); Daekeun YOON, Beijing (CN); Qing MA, Beijing (CN); Rui HAN, Beijing (CN); Donglong LIN, Beijing (CN); Zeyuan TONG, Beijing (CN); Wenyang LI, Beijing (CN); Fujian REN, Beijing (CN); Zhipeng ZHANG, Beijing (CN); Bin LONG, Beijing (CN); Peng WU, Beijing (CN); Fei DONG, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/132,738

(22) Filed: Sep. 17, 2018

(30) Foreign Application Priority Data
Sep. 29, 2017 (CN) 201710908528.2

(51) Int. Cl. F21V 8/00

(52) U.S. Cl. CPC G02B 6/0055; G02F 1/133603; G02B 6/0073

(57) ABSTRACT

Embodiments of the present disclosure provide a light guide plate, a light guide plate module, a backlight module and a display device. The light guide plate includes a light-exiting surface and a bottom surface disposed opposite to each other; and a light-entering side and a plurality of side surfaces arranged between the light-exiting surface and the bottom surface. At least one of the plurality of side surfaces is provided thereon with at least one light-deflecting structure that is configured to reflect part of light emitted from the at least one side surface to at least one selected area inside the light guide plate.

### CROSS-REFERENCE TO RELATED APPLICATION

This application claims priority to Chinese Patent Application No. 201710908528.2 filed on Sep. 29, 2017, which is incorporated herein by reference in its entirety.

### TECHNICAL FIELD

The present disclosure relates to the field of display technology, in particular to a light guide plate, a light guide plate module, a backlight module, and a display device.

### BACKGROUND

In a traditional backlight module, after LED light enters the light guide plate through a light-entering side of the light guide plate, part of the light will be emitted from a side surface of the light guide plate.

### SUMMARY

In a first aspect, an embodiment of the present disclosure provides a light guide plate that includes a light-exiting surface and a bottom surface opposite to each other; and a light-entering side and a plurality of side surfaces located between the light-exiting surface and the bottom surface. At least one of the plurality of side surfaces is provided thereon with at least one light-deflecting structure that is configured to reflect part of light emitted from the at least one side surface to at least one selected area inside the light guide plate.

In some embodiments, the selected area includes a corner area in an effective light-exiting region of the light guide plate.

In some embodiments, the light-deflecting structure includes at least one first reflective surface structure, each first reflective surface structure includes a plurality of first reflective sub-surfaces, and at least a portion of the first reflective sub-surfaces and adjacent first reflective sub-surfaces thereof have different inclination angles with respect to the light-entering side. The plurality of first reflective sub-surfaces forms a first cavity or a first protrusion to allow light emitted from the inside of the light guide plate towards the outside of the light guide plate to be reflected and then enter the corresponding selected area inside the light guide plate.

In some embodiments, the light-deflecting structure includes at least one first curved reflective surface structure that forms a second cavity or a second protrusion to allow light emitted from the inside of the light guide plate towards the outside of the light guide plate to be reflected and then enter the corresponding selected area inside the light guide plate.

In some embodiments, the at least one light-deflecting structure is integrally formed on the at least one side surface of the light guide plate.

In some embodiments, an orthogonal projection of the light-deflecting structure on its corresponding side surface has a width that is not less than one third of a width of the side surface.

In some embodiments, the first reflective surface structure or the first curved reflective surface structure has a micrometer-level outer diameter.

In a second aspect, an embodiment of the present disclosure further provides a light guide plate module that includes: a light guide plate including a light-exiting surface and a bottom surface opposite to each other, and a light-entering side and a plurality of side surfaces located between the light-exiting surface and the bottom surface; and a frame configured to fix the light guide plate and at least partly surrounding the side surfaces of the light guide plate. At least one light-deflecting structure is provided on at least one inner surface of the frame facing at least one of the side surfaces, and configured to reflect part of light emitted from the at least one side surfaces to at least one selected area inside the light guide plate.

In some embodiments, the selected area includes a corner area in an effective light-exiting region of the light guide plate.

In some embodiments, the light-deflecting structure includes at least one second reflective surface structure, each second reflective surface structure includes a plurality of second reflective sub-surfaces, and at least a portion of the second reflective sub-surfaces and adjacent second reflective sub-surfaces thereof have different inclination angles with respect to the light-entering side. The second reflective surface structure forms a third cavity or a third protrusion to allow light emitted from the inside of the light guide plate towards the outside of the light guide plate to be reflected and then enter the corresponding selected area inside the light guide plate.

In some embodiments, the light-deflecting structure includes at least one second curved reflective surface structure that forms a fourth cavity or a fourth protrusion to allow light emitted from the inside of the light guide plate towards the outside of the light guide plate to be reflected and then enter the corresponding selected area inside the light guide plate.

In some embodiments, an orthogonal projection of the light-deflecting structure on its corresponding side surface has a width that is not less than one third of a width of the side surface.

In some embodiments, the second reflective surface structure or the second curved reflective surface structure has a micrometer-level outer diameter.

In some embodiments, the frame is a plastic frame.

In some embodiments, the frame is an iron frame.

In some embodiments, the frame is a backplane.

In a third aspect, an embodiment of the present disclosure further provides a backlight module that includes the light guide plate module as described above and a light source. The light-entering side of the light guide plate faces the light source.

In a fourth aspect, an embodiment of the present disclosure further provides a display device that includes the backlight module as described above.

### BRIEF DESCRIPTION OF THE DRAWINGS

In order to illustrate the technical solutions of the embodiments of the present disclosure more clearly, accompanying drawings necessary for the description of the embodiments of the present disclosure will be briefly described. Apparently, the drawings described in the following are merely some of the embodiments of the present disclosure, and based on these drawings, other drawings can be further obtained by a person having ordinary skills in the art without exercising inventive skills.

FIG. 1 is a schematic view showing the poor condition of dark corners in the AA region of the backlight module in the related art;

FIG. 2 is a structural schematic view showing a light guide plate provided in an embodiment of the present disclosure;

FIG. 3 is a structural schematic view showing the application of the light guide plate provided in an embodiment of the present disclosure to a backlight module; and

FIG. 4 is a structural schematic view showing a light guide plate module provided in an embodiment of the present disclosure.

### DETAILED DESCRIPTION

In order to make the object, technical solutions and advantages of the embodiments of the present disclosure more apparent, the technical solutions of the embodiments of the present disclosure will be clearly and completely described hereinafter with reference to the drawings of the embodiments of the present disclosure. Apparently, the described embodiments are merely part, but not all, of the embodiments of the present disclosure. All other embodiments obtained by a person having ordinary skills based on the described embodiments should fall within the scope of protection of the present disclosure.

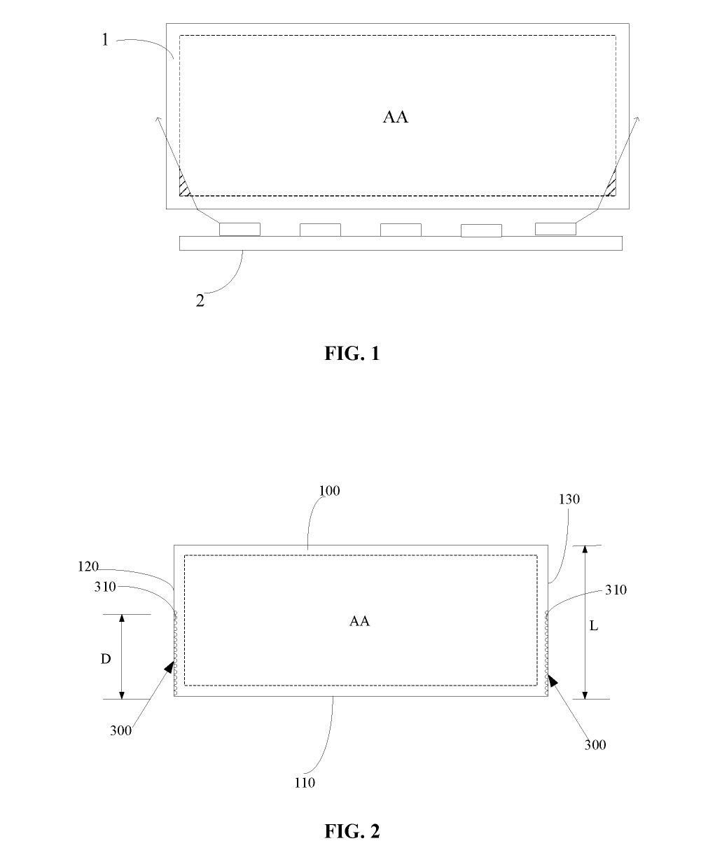

In the process of designing a liquid crystal display (LCD) screen such as a vehicle-mounted liquid crystal display screen, as shown in FIG. 1, sometimes a phenomenon that LED light cannot reach corners of the AA region of the backlight module will occur due to various reasons such as structural limitations of the light guide plate 1 or a fact that protruding connectors disposed at ends of an LED light bar 2 occupy positions of LEDs and thus result in further distances of the LEDs at both ends of the LED light bar 2 from the AA region (an effective display region) of the backlight module. As a result, there will be a phenomenon that there is no light at the corners of the AA region of the backlight module, i.e., dark corners appear.

Embodiments of the present disclosure provide a light guide plate, a light guide plate module, a backlight module and a display device, which are capable of deflecting at least part of light emitted from side surfaces of the light guide plate to at least one selected area inside the light guide plate to solve the problem.

As described above, the terms such as “AA region” and “effective light-exiting region” here refer to an effective irradiation region by light which is directed out when a corresponding light source such as the light guide plate is in use. For example, when a combination of the light guide plate and a light source is used in a backlight source of a display panel or the like, the effective light-exiting region of the light guide plate is a region where light can be uniformly diffused to provide a surface light source for the display panel.

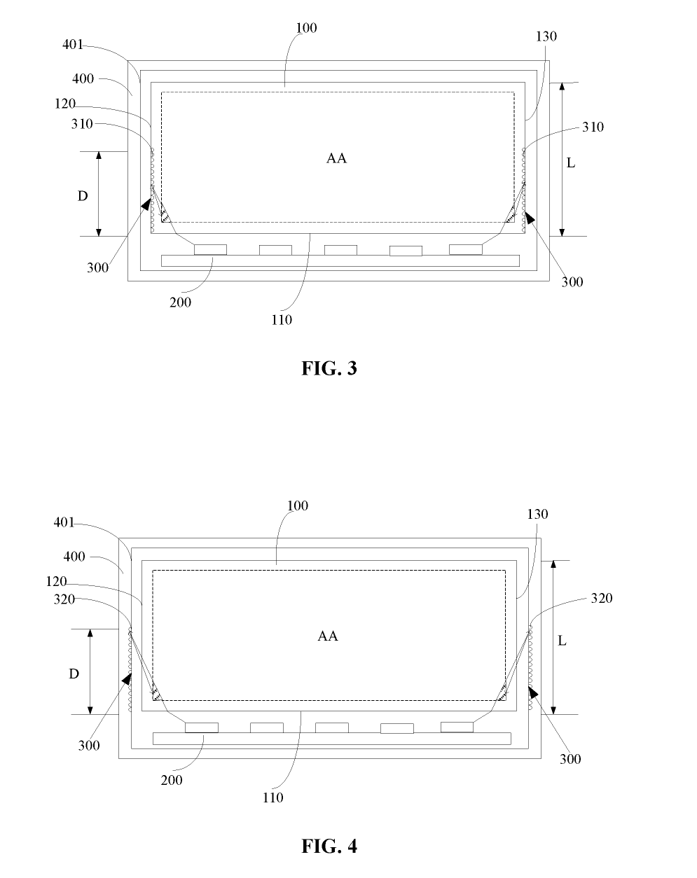

In some embodiments, as shown in FIG. 2 and FIG. 3, the light guide plate 100 provided in the present disclosure includes a light-exiting surface and a bottom surface disposed opposite to each other, and a light-entering side 110 and a plurality of side surfaces arranged between the light-exiting surface and the bottom surface. At least one of the plurality of side surfaces is provided thereon with at least one light-deflecting structure 300 that is configured to reflect part of light emitted from the at least one side surface to at least one selected area inside the light guide plate 100.

The light guide plate 100 according to this embodiment of the present disclosure is provided with the at least one light-deflecting structure 300 on the at least one side surface of the light guide plate 100, making it possible to deflect at least part of the light emitted from the at least one side surface of the light guide plate 100 towards the outside of the light guide plate 100 and make the deflected light transmitted to the at least one selected area which requires light compensation (enhancement or improvement) inside the light guide plate 100, for example, dark corner areas in the AA region of the light guide plate 100. As a result, the technical problem of the dark corners in the AA region of the backlight module in the related art is improved.

In some embodiments, the selected area includes a corner area of the effective light-exiting region of the light guide plate 100, close to the light-entering side 110 of the light guide plate 100.

According to the above solution, the light-deflecting structure 300 can deflect the light emitted from the inside of the light guide plate 100 towards the outside of the light guide plate 100 to the corresponding corner area in the AA region of the light guide plate 100, to compensate for light in the corresponding corner area in the AA region of the light guide plate 100, thereby improving the poor condition of the dark corner in the AA region of the light guide plate 100 in the related art.

It can be naturally understood that the light-deflecting structure 300 is not limited to deflecting the light emitted from the inside of the light guide plate 100 towards the outside of the light guide plate 100 to the corner areas in the AA region of the light guide plate 100, and that when dark areas appear in other areas inside the light guide plate 100 due to structural limitations or the like, it may be also possible to provide at least one light-deflecting structure 300 on at least one side surface of the light guide plate 100 to deflect light emitted from the at least one side surface of the light guide plate 100 to at least one positions where the dark areas are located.

In some embodiments, in the provided light guide plates, the light-deflecting structure 300 includes at least one first reflective surface structure, each first reflective surface structure includes a plurality of first reflective sub-surfaces, and at least a portion of the first reflective sub-surfaces and adjacent first reflective sub-surfaces thereof have different inclination angles with respect to the light-entering side 110.

Comparing with a planar reflective sheet which can hardly reflect light emitted from the side surface of the light guide plate to the corner areas in the AA region of the light guide plate, according to the technical solution of the above embodiment, the light-deflecting structure 300 reflects the light by the first reflective surface structure formed on the corresponding side surface of the light guide plate 100, and the first reflective surface structure includes a plurality of first reflective sub-surfaces which have different inclination angles, respectively. Moreover, the inclination angle of each reflective sub-surface can be designed based on actual needs such as the model of the backlight module, so as to enable light emitted from the inside of the light guide plate 100 towards the outside of the light guide plate 100 to be reflected just into the corresponding selected area such as the corner area in the AA region inside the light guide plate 100.

It can be understood that the light-deflecting structure 300 may also achieve the purpose of changing the light path in other ways.

In some embodiments, the plurality of first reflective sub-surfaces form a first cavity to allow light emitted from the inside of the light guide plate 100 towards the outside of the light guide plate 100 to be reflected and then enter the corresponding selected area inside the light guide plate 100.

According to the technical solution of the above embodiment, the plurality of first reflective sub-surfaces forms the first cavity. That is, a plurality of concave structures (i.e., the first cavity) is directly formed on the corresponding side surface of the light guide plate 100, and an inner wall of the concave structure is formed by the plurality of reflective sub-surfaces having different inclination angles. The concave structures on the corresponding side surface of the light guide plate are used to deflect light so that light emitted from the inside of the light guide plate 100 towards the outside of the light guide plate 100 is transmitted into the corresponding selected area inside the light guide plate 100. Such structures are simple, easy to implement and directly formed on the light guide plate 100 without having any additional components included.

In some embodiments, the light-deflecting structure 300 is integrally formed on the corresponding side surface of the light guide plate 100.

According to the above solution, when making the light guide plate 100, the first cavity can be integrally formed on the light guide plate 100, and this process is simple.

It can be understood that the first cavity may also be provided on the corresponding side surface of the light guide plate 100 by post-processing or in other ways.

In some embodiments, the plurality of first reflective sub-surfaces may also form a first protrusion. That is, it is possible to achieve the purpose of deflecting the light emitted from the corresponding side surface of the light guide plate 100 back into the corresponding selected area inside the light guide plate 100 by forming a plurality of convex structures on the corresponding side surface of the light guide plate 100 and designing the inclination angles of the reflective sub-surfaces of the first protrusion based on actual needs such as the model of the backlight module.

In some embodiments, as shown in FIG. 2 and FIG. 3, an orthogonal projection of the light-deflecting structure 300 on its corresponding side surface has a width D that is not less than one third of a width L of the side surface.

According to the above solution, the number of the concave structures (i.e., the first cavity) or the convex structures (i.e., the first protrusion) on the corresponding side surface of the light guide plate 100 is more than one, and their range of distribution should cover at least one third of the side surface of the light guide plate 100. In this way, the corner areas in the AA region of the light guide plate 100 can be further improved so that there is no dead corner where no light arrives.

In some embodiments, the first reflective surface structure has a micrometer-level outer diameter.

According to the above solution, the area that the reflected light can reach can be effectively improved.

In some embodiments, as shown in FIG. 2 and FIG. 3, the plurality of side surfaces of the light guide plate 100 includes a first side surface 120 and a second side surface 130 adjacent to the light-entering side 110. The light-deflecting structures 300 are disposed on the first side surface 120 and the second side surface 130 of the light guide plate 100 respectively, and arranged on their side close to the light-entering side 110 of the light guide plate 100.

Since the dark corners in the AA region of the light guide plate 100 are usually formed on its side close to the light-entering side 110 of the light guide plate 100, it is possible to effectively improve the coverage on the dark areas by the reflected light by disposing the light-deflecting structures 300 on two side surfaces of the light guide plate 100 adjacent to the light-entering side 110.

It shall be noted that, in other embodiments of the present disclosure, the light-deflecting structures 300 may also be disposed at other positions when the light emitted from the side surfaces of the light guide plate 100 needs to be transmitted to other areas inside the light guide plate 100.

In some embodiments, as shown in FIG. 2 and FIG. 3, the light-deflecting structure 300 includes at least one first curved reflective surface structure that forms a second cavity 310 to allow light emitted from the inside of the light guide plate 100 towards the outside of the light guide plate 100 to be reflected and then enter the corresponding selected area inside the light guide plate 100.

In the related art, it is common to attach a reflective sheet to the side surface of the light guide plate 100. The attached reflective sheet is a planar reflective sheet and cannot reflect light emitted from the side surface of the light guide plate 100 to the corner area in the AA region of the light guide plate 100. However, according to the solution of the above embodiment, the light-deflecting structure 300 reflects the light by the first curved reflective surface structure formed on the side surface of the light guide plate 100, and the first curved reflective surface structure has a curved shape which can be designed based on actual needs such as the model of the backlight module, so as to enable the light emitted from the inside of the light guide plate 100 towards the outside of the light guide plate 100 to be reflected into the corresponding selected area such as the corner area in the AA region inside the light guide plate 100. Moreover, the first curved reflective surface structure forms the second cavity 310. That is, a plurality of concave structures (i.e., the second cavity 310) having curved inner walls is directly formed on the corresponding side surface of the light guide plate 100. The concave structures on the side surface of the light guide plate 100 are used to deflect light so that light emitted from the inside of the light guide plate 100 towards the outside of the light guide plate 100 is transmitted into the corresponding selected area inside the light guide plate 100. Such structures are simple, easy to implement and directly formed on the light guide plate 100 without having any additional components included.

It can be understood that the light-deflecting structure 300 may also achieve the purpose of changing the light path in other ways.

In some embodiments, the light-deflecting structure 300 is integrally formed on the corresponding side surface of the light guide plate 100.

According to the technical solution of the above embodiment, when making the light guide plate 100, the second cavity 310 is integrally formed on the light guide plate 100, and this process is simple.

It can be understood that the second cavity 310 may be also provided on the corresponding side surface of the light guide plate 100 by post-processing or in other ways.

In some embodiments, the first curved reflective surface structure may also form a second protrusion. That is, it is possible to achieve the purpose of deflecting the light emitted from the corresponding side surface of the light guide plate 100 back into the corresponding selected area inside the light guide plate 100 by forming a plurality of convex structures on the side surface of the light guide plate 100 and reasonably designing the curved shape of the protrusion based on actual needs such as the model of the backlight module.

In some embodiments, as shown in FIG. 2 and FIG. 3, an orthogonal projection of the light-deflecting structure 300 on its corresponding side surface has a width D that is not less than one third of the width L of the side surface.

According to the technical solution of the above embodiment, the number of the concave structures (i.e., the second cavity) or convex structures (i.e., the second protrusion) on the corresponding side surface of the light guide plate 100 is more than one, and their range of distribution should cover at least one third of the corresponding side surface of the light guide plate 100. In this way, it is possible to further realize no dead corner where no light arrives in the corner area of the AA region of the light guide plate 100.

In some embodiments, the first curved reflective surface structure has a micrometer-level outer diameter, and the second cavity 310 or the second protrusion has a micrometer-level outer diameter, which makes it possible to effectively improve the area that the reflected light can reach.

In some embodiments, as shown in FIG. 2 and FIG. 3, the plurality of side surfaces of the light guide plate 100 includes a first side surface 120 and a second surface 130 adjacent to the light-entering side 110. The light-reflecting structures 300 are disposed on the first side surface 120 and the second side surface 130 of the light guide plate 100 respectively, and arranged on their side close to the light-entering side 110 of the light guide plate 100.

Since the dark corners in the AA region of the light guide plate 100 are formed on its side close to the light-entering side 110 of the light guide plate 100, in the technical solution of the above embodiment, it is possible to allow the reflected light to effectively cover the dark areas by disposing the light-deflecting structures 300 on two side surfaces of the light guide plate 100 adjacent to the light-entering side 110 and arranging the light-deflecting structures 300 at positions close to the light-entering side 110 of the light guide plate 100.

It should be noted that, in some embodiments of the present disclosure, the light-deflecting structures 300 may also be disposed at other positions when the light emitted from the side surfaces of the light guide plate 100 needs to be transmitted to other areas inside the light guide plate 100.

It shall be noted that, in some embodiments, the selection of the micrometer-level first reflective surface structure is made in consideration of various needs such as cost and processing. It will be readily understood by a person skilled in the art that forming the first reflective surface structure to have a smaller outer diameter, for example, submicron- or nanometer-level, which is capable of realizing finer control of the reflection angle of light is also feasible for the technical solution of the present disclosure.

Here, the terms of “micrometer-level”, “submicron-level” and “nanometer-level” are common knowledge in the field of engineering technology. For example, the micrometer-level corresponds to a range of 1 to 100 micrometers, the submicron-level corresponds to a range of 0.1 to 1 micrometer, and the nanometer-level corresponds to a range of 1 to 100 nanometers.

Some embodiments of the present disclosure further provide a light guide plate module, which includes a light guide plate 100 and a frame 400 for fixing the light guide plate 100. The light guide plate 100 includes a light-exiting surface and a bottom surface disposed opposite to each other, and a light-entering side 110 and a plurality of side surfaces arranged between the light-exiting surface and the bottom surface. The frame 400 at least partly surrounds the side surfaces of the light guide plate 100. At least one light-deflecting structure 300 is provided on at least one inner surface 401 of the frame 400 facing at least one of the side surfaces, and configured to reflect part of light emitted from the at least one side surfaces to at least one selected area inside the light guide plate 100.

In some embodiments, the frame 400 may be a plastic frame, an iron frame or a backplane adjacent to the light guide plate.

In some embodiments, the light-deflecting structure 300 is disposed on the frame 400 adjacent to the light guide plate 100.

In some embodiments, the light-deflecting structure 300 may be directly formed on the plastic frame. Through the light-deflecting structure 300 on the plastic frame, light emitted from the corresponding side surface of the light guide plate 100 is deflected to change its path and reach the corresponding selected area which originally required light compensation such as a dark corner area in the AA region of the light guide plate 100. As a result, the poor condition of the dark corners in the AA region of the backlight module is improved or eliminated.

In some embodiments, as shown in FIG. 4, the selected area includes a corner area in the effective light-exiting region of the light guide plate 100.

According to the technical solution of the above embodiment, the light-deflecting structure 300 can deflect the light emitted from the inside of the light guide plate 100 towards the outside of the light guide plate 100 to the corresponding corner area in the AA region of the light guide plate 100, so as to achieve the light compensation of the corner area in the AA region of the light guide plate 100. As a result, the poor condition of the dark corners in the AA region of the light guide plate 100 in the related art is improved.

It can be understood that the light-deflecting structure 300 is not limited to deflecting the light emitted from the inside of the light guide plate 100 towards the outside of the light guide plate 100 to the corner areas in the AA region of the light guide plate 100, and that when dark areas appear in other areas inside the light guide plate 100 due to structural limitations or the like, it may be also possible to provide at least one light-deflecting structure 300 on at least one side surface of the light guide plate 100 to deflect light emitted from the at least one side surface of the light guide plate 100 to at least one positions where the dark areas are located.

In some embodiments, the light-deflecting structure 300 includes at least one second reflective surface structure, each second reflective surface structure includes a plurality of second reflective sub-surfaces, and at least a portion of the second reflective sub-surfaces and adjacent second reflective sub-surfaces thereof have different inclination angles with respect to the light-entering side 110.

In the related art, it is common to attach a reflective sheet to the side surface of the light guide plate 100. The attached reflective sheet is a planar reflective sheet and cannot reflect light emitted from the side surface of the light guide plate 100 to the corner areas in the AA region of the light guide plate 100. However, according to the technical solution of the above embodiment, the light-deflecting structure 300 reflects the light by the second reflective surface structure formed on the corresponding inner surface 401 of the frame 400, and the second reflective surface structure includes a plurality of second reflective sub-surfaces which have different inclination angles, respectively. Moreover, the inclination angle of each second reflective sub-surface can be designed based on actual needs such as the model of the backlight module, so as to enable light emitted from the inside of the light guide plate 100 towards the outside of the light guide plate 100 to be reflected just into the selected area such as the corner areas in the AA region inside the light guide plate 100.

It can be understood that, the light-deflecting structure 300 may also achieve the purpose of changing the light path in other ways.

In some embodiments, the second reflective surface structure forms a third cavity to allow light emitted from the inside of the light guide plate 100 towards the outside of the light guide plate 100 to be reflected and then enter the corresponding selected area inside the light guide plate 100.

According to the technical solution of the embodiment, the plurality of second reflective sub-surfaces forms the third cavity. That is, a plurality of concave structures (i.e., the third cavity) is directly formed on the corresponding inner surface 401 of the frame 400, and an inner wall of the concave structure is formed by the plurality of reflective sub-surfaces having different inclination angles. The concave structures on the corresponding inner surface 401 of the frame 400 are used to deflect light so that light emitted from the inside of the light guide plate 100 towards the outside of the light guide plate 100 is transmitted into the corresponding selected area inside the light guide plate 100. Such structures are simple, easy to implement and directly formed on the frame 400 without having any additional components included.

In some embodiments, the light-deflecting structure 300 is integrally formed on the frame 400.

With the technical solution of the above embodiment, when making the frame 400 such as a plastic frame, an iron frame, or a backplane, the third cavity can be integrally formed at a corresponding position on the frame 400, and this process is simple.

It can be understood that, the third cavity may be also provided on the corresponding inner surface 401 of the frame 400 by post-processing or in other ways.

In some embodiments, the plurality of second reflective sub-surfaces may also form a third protrusion. That is, it is possible to achieve the purpose of deflecting the light emitted from the corresponding side surface of the light guide plate 100 back into the corresponding selected area inside the light guide plate 100 by forming a plurality of convex structures on the corresponding inner surface 401 of the frame 400 and reasonably designing the inclination angles of the reflective sub-surfaces of the third protrusion based on actual needs such as the model of the backlight module.

In some embodiments, as shown in FIG. 4, an orthogonal projection of the light-deflecting structure 300 on its corresponding side surface of the light guide plate 100 has a width D that is not less than one third of the width L of the side surface.

According to the technical solution of the above embodiment, the number of the concave structures (i.e., the third cavity) or convex structures (i.e., the third protrusion) on the corresponding inner surface 401 of the frame 400 is more than one, and their range of distribution should at least cover one third of the corresponding side surface of the light guide plate 100. In this way, it is possible to further realize no dead corner where no light arrives in the corner area in the AA region of the light guide plate 100.

In some embodiments, the second reflective surface structure has a micrometer-level outer diameter.

According to the technical solution of the above embodiment, the third cavity or the third protrusion has a micrometer-level outer diameter, which makes it possible to effectively improve the reflection angle of light so as to make the reflected light better cover the dark corner areas.

In some embodiments, the plurality of side surfaces of the light guide plate 100 includes a first side surface 120 and a second side surface 130 adjacent to the light-entering side 110. The light-deflecting structures 300 are disposed on inner surfaces 401 of the frame 400 corresponding to the first side surface 120 and the second side surface 130 of the light guide plate 100, and are arranged on their side close to the light-entering side 110 of the light guide plate 100.

Since the dark corners in the AA region of the light guide plate 100 are formed on its side close to the light-entering side 110 of the light guide plate 100, in the technical solutions of the above embodiment, it is possible to improve the coverage of the dark corner areas by the reflected light by disposing the light-deflecting structures 300 on two side surfaces of the light guide plate 100 adjacent to the light-entering side 110, and arranging the light-deflecting structures 300 at positions close to the light-entering side 110 of the light guide plate 100.

In some embodiments, when the light emitted from the side surface of the light guide plate 100 needs to be transmitted to other areas inside the light guide plate 100, the light-deflecting structure 300 may also be disposed at other positions.

In some embodiments, the light-deflecting structure 300 includes at least one second curved reflective surface structure that forms a fourth cavity 320 to allow light emitted from the inside of the light guide plate 100 towards the outside of the light guide plate 100 to be reflected and then enter the corresponding selected area inside the light guide plate 100.

In the related art, it is common to attach a reflective sheet to the side surface of the light guide plate 100. The attached reflective sheet is a planar reflective sheet and cannot reflect light emitted from the side surface of the light guide plate 100 to the corner areas in the AA region of the light guide plate 100. However, according to the technical solution of the above embodiment, the light-deflecting structure 300 reflects the light by the at least one second curved reflective surface structure formed on the at least one inner surfaces 401 of the frame 400, and the second curved reflective surface structure has a curved shape which can be designed based on actual needs such as the model of the backlight module, so as to enable the light emitted from the inside of the light guide plate 100 towards the outside of the light guide plate 100 to be reflected just into the selected area such as the corner area in the AA region inside the light guide plate 100. Moreover, the second curved reflective surface structure forms the fourth cavity 320. That is, a plurality of concave structures (i.e., the fourth cavity 320) having curved inner walls is directly formed on the corresponding inner surface 401 of the frame 400. The concave structures on the corresponding inner surface 401 of the frame 400 are used to deflect the light so that light emitted from the inside of the light guide plate 100 towards the outside of the light guide plate 100 is transmitted into the selected area inside the light guide plate 100. Such structures are simple, easy to implement and directly formed on the frame 400 without having any additional components included.

It can be understood that, the light-deflecting structure 300 may also achieve the purpose of changing the light path in other ways.

In some embodiments, the light-deflecting structure 300 is integrally formed on the corresponding inner surface 401 of the frame 400.

According to the technical solution of the embodiments, when making the light guide plate 100, the fourth cavity 320 is integrally formed on the frame 400, and this process is simple.

It can be understood that, the fourth cavity 320 may be also formed on the corresponding inner surface 401 of the frame 400 by post-processing or in other ways.

In some embodiments, the second curved reflective surface structure may also form a fourth protrusion. That is, it is possible to achieve the purpose of deflecting the light emitted from the corresponding side surface of the light guide plate 100 back into the corresponding selected area inside the light guide plate 100 by forming a plurality of convex structures on the corresponding inner surface 401 of the frame 400 and reasonably designing the curved shape of the protrusion based on actual needs such as the model of the backlight module.

In some embodiments, an orthogonal projection of the light-deflecting structure 300 on its corresponding side surface has a width D that is not less than one third of the width L of the side surface.

According to the technical solution of the above embodiments, the number of the concave structures (i.e., the fourth cavity 320) or convex structures (i.e., the fourth protrusion) on the corresponding inner surface 401 of the frame 400 is more than one, and their range of distribution should cover at least one third of the side surface of the light guide plate 100. In this way, it is possible to further realize no dead corner where no light arrives in the corner area of the AA region of the light guide plate 100.

In some embodiments, the second curved reflective surface structure has a micrometer-level outer diameter. Using the above solution, the fourth cavity 320 or the fourth protrusion has a micrometer-level outer diameter, which can improve the reflection angle of light, thereby making the reflected light better cover the dark corner areas.

In some embodiments, the plurality of side surfaces of the light guide plate 100 includes a first side surface 120 and a second side surface 130 adjacent to the light-entering side 110. The light-deflecting structures 300 are disposed on the corresponding inner surfaces 401 on two sides of the frame 400 corresponding to the first side surface 120 and the second side surface 130 of the light guide plate 100, and distributed on their side close to the light-entering side 110 of the light guide plate 100.

Since the dark corners in the AA region of the light guide plate 100 are formed on its side close to the light-entering side 110 of the light guide plate 100, in the technical solutions of the above embodiments, the light-deflecting structures 300 are disposed on two side surfaces of the light guide plate 100 adjacent to the light-entering side 110, and arranged at positions close to the light-entering side 110 of the light guide plate 100.

In some embodiments, when the light emitted from the side surface of the light guide plate 100 needs to be transmitted to other areas inside the light guide plate 100, the light-deflecting structures 300 may be also provided at other positions.

It should be noted that, in the above embodiments, the selection of the micrometer-level first reflective surface structure is made in consideration of various needs such as cost and processing. It will be readily understood by a person skilled in the art that forming the first reflective surface structure to have a smaller outer diameter, for example, submicron- or nanometer-level, which is capable of realizing finer control of the reflection angle of light is also feasible for the technical solution of the present disclosure.

Here, the terms of “micrometer-level”, “submicron-level” and “nanometer-level” are common knowledge in the field of engineering technology. For example, the micrometer scale corresponds to a range of 1 to 100 micrometers, the submicron scale corresponds to a range of 0.1 to 1 micrometer, and the nanometer scale corresponds to a range of 1 to 100 nanometers.

Some embodiments of the present disclosure further provide a backlight module that includes the light guide plate module as described above and a light source 200. The light-entering side 110 of the light guide plate 100 faces the light source 200.

Some embodiments of the present disclosure further provide a display device that includes the backlight module provided in the above embodiments. The display device may be various display devices such as a mobile phone and a computer, which may be used in, for example, a vehicle-mounted display device.

It should be pointed out that several improvements and substitutions made be made by a person having ordinary skills in the art without departing from the technical principle of the present disclosure, and such improvements and substitutions shall be also considered as falling within the protection scope of the present disclosure.

What is claimed is:

1. A light guide plate comprising:
a light-exiting surface and a bottom surface opposite to each other; and
a light-entering side and a plurality of side surfaces located between the light-exiting surface and the bottom surface;
wherein at least one of the plurality of side surfaces is provided thereon with at least one light-deflecting structure that is configured to reflect part of light emitted from the at least one side surface to at least one selected area inside the light guide plate.

2. The light guide plate according to claim 1, wherein the at least one selected area comprises a corner area in an effective light-exiting region of the light guide plate.

3. The light guide plate according to claim 1, wherein the at least one light-deflecting structure comprises at least one first reflective surface structure, each first reflective surface structure comprises a plurality of first reflective sub-surfaces, and at least a portion of the first reflective sub-surfaces and adjacent first reflective sub-surfaces thereof have different inclination angles with respect to the light-entering side; and the plurality of first reflective sub-surfaces forms a first cavity or a first protrusion to allow light emitted from the inside of the light guide plate towards the outside of the light guide plate to be reflected and then enter the corresponding selected area inside the light guide plate.

4. The light guide plate according to claim 1, wherein the at least one light-deflecting structure comprises at least one first curved reflective surface structure that forms a second cavity or a second protrusion to allow light emitted from the inside of the light guide plate towards the outside of the light guide plate to be reflected and then enter the corresponding selected area inside the light guide plate.

5. The light guide plate according to claim 1, wherein the at least one light-deflecting structure is integrally formed on the at least one side surface of the light guide plate.

6. The light guide plate according to claim 5, wherein an orthogonal projection of the light-deflecting structure on its corresponding side surface has a width that is not less than one third of a width of the side surface.

7. The light guide plate according to claim 3, wherein the first reflective surface structure has a micrometer-level outer diameter.

8. The light guide plate according to claim 4, wherein the first curved reflective surface structure has a micrometer-level outer diameter.

9. A light guide plate module comprising:
a light guide plate comprising a light-exiting surface and a bottom surface opposite to each other, and a light-entering side and a plurality of side surfaces located between the light-exiting surface and the bottom surface; and
a frame configured to fix the light guide plate and at least partly surrounding the side surfaces of the light guide plate, wherein at least one light-deflecting structure is provided on at least one inner surface of the frame facing at least one of the side surfaces, and configured to reflect part of light emitted from the at least one side surfaces to at least one selected area inside the light guide plate.

10. The light guide plate module according to claim 9, wherein the at least one selected area comprises a corner area in an effective light-exiting region of the light guide plate.

11. The light guide plate module according to claim 9, wherein the at least one light-deflecting structure comprises at least one second reflective surface structure, each second reflective surface structure comprises a plurality of second reflective sub-surfaces, and at least a portion of the second reflective sub-surfaces and adjacent second reflective sub-surfaces thereof have different inclination angles with respect to the light-entering side; and the second reflective surface structure forms a third cavity or a third protrusion to allow light emitted from the inside of the light guide plate towards the outside of the light guide plate to be reflected and then enter the corresponding selected area inside the light guide plate.

12. The light guide plate module according to claim 9, wherein the at least one light-deflecting structure comprises at least one second curved reflective surface structure that forms a fourth cavity or a fourth protrusion to allow light emitted from the inside of the light guide plate towards the outside of the light guide plate to be reflected and then enter the corresponding selected area inside the light guide plate.

13. The light guide plate module according to claim 9, wherein an orthogonal projection of the light-deflecting structure on its corresponding side surface has a width that is not less than one third of a width of the side surface.

14. The light guide plate module according to claim 11, wherein the second reflective surface structure has a micrometer-level outer diameter.

15. The light guide plate module according to claim 12, wherein the second curved reflective surface structure has a micrometer-level outer diameter.

16. The light guide plate module according to claim 9, wherein the frame is a plastic frame.

17. The light guide plate module according to claim 9, wherein the frame is an iron frame.

18. The light guide plate module according to claim 9, wherein the frame is a backplane.

19. A backlight module comprising the light guide plate module according to claim 9 and a light source, wherein the light-entering side of the light guide plate faces the light source.

20. A display device comprising the backlight module of claim 19.
